(19) United States
(12) Patent Application Publication
(10) Pub. No.: US 2013/0173682 A1
(43) Pub. Date: Jul. 4, 2013

(54) FLOATING-POINT ERROR PROPAGATION IN DATAFLOW

(71) Applicant: Marko Radmilac, Bellevue, WA (US)

(72) Inventor: Marko Radmilac, Bellevue, WA (US)

(73) Assignee: MICROSOFT CORPORATION, Redmond, WA (US)

(21) Appl. No.: 13/339,184

(22) Filed: Dec. 28, 2011

(51) Int. Cl. G06F 7/483

(52) U.S. Cl. 708/507; 708/495

(57) ABSTRACT

A process for propagating an error in a floating-point calculation is disclosed. A floating-point error occurring from the floating-point arithmetic calculation is trapped, and a special value is generated. Information regarding the error is stored as a payload of the special value. Program operations are resumed with the special value applied to further calculations dependent on the floating-point arithmetic calculation.

### BACKGROUND

Dataflow programming focuses on how things connect, unlike imperative programming, which focuses on how things happen. In imperative programming, a program is modeled as a series of operations; the flow of data between these operations is of secondary concern to the behavior of the operations themselves. Dataflow programming, however, often models programs as a series of interdependent connections, with the operations between these connections being of secondary importance. Thus, dataflow is a software architecture based on a premise that changing the value of a variable should automatically recalculate of the values of variables that depend on the value. Spreadsheets are an often-cited embodiment of dataflow, but many other embodiments exist.

Dataflow programming provides an ability to make parallel processing easier than in imperative programming. In parallel processing, state information is shared across parallel processors. Imperative programming can introduce non-determinism and other undesirable effects in cases of concurrent execution without proper synchronization. In a dataflow, however, the task of maintaining state is removed from the developer and provided, instead, to the language runtime. When an operation completes, the dataflow program automatically scans for an operation where all of the inputs are currently valid. When that operation finishes, it will typically put data into one or more outputs, thereby making some other operation become valid. Dataflow permits highly parallelizable operations to exist while the program appears to execute sequentially.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Invalid operations and other errors in floating point calculations are particularly vexing in parallel applications. Such errors in control flow programming can lead to unpredictable results that can be difficult to discover and address. Dataflow is better suited to discover and address these errors, but present dynamic error checking mechanisms negatively affect the performance of calculations. This disclosure relates to a process for propagating floating point error in dataflow. In one example, a large number of parallelized floating point arithmetic calculations in along a main path of a dataflow. A floating-point error occurring from an invalid operation of a floating-point arithmetic calculation is trapped, and a special value such as a Not-a-Number, is generated. Information regarding the error is stored as a payload of the special value. Program operations along the main path are resumed with the special value applied to further calculations dependent on the floating-point arithmetic calculation.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated, as they become better understood by reference to the following detailed description. The elements of the drawings are not necessarily to scale relative to each other. Like reference numerals designate corresponding similar parts.

FIG. 1 is a block diagram illustrating an example of a computing device.

FIG. 2 is a block diagram illustrating an example process for propagating errors in floating point calculations using dataflow with the computing device of FIG. 1.

### DETAILED DESCRIPTION

In the following Detailed Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that features of the various exemplary embodiments described herein may be combined with each other, unless specifically noted otherwise.

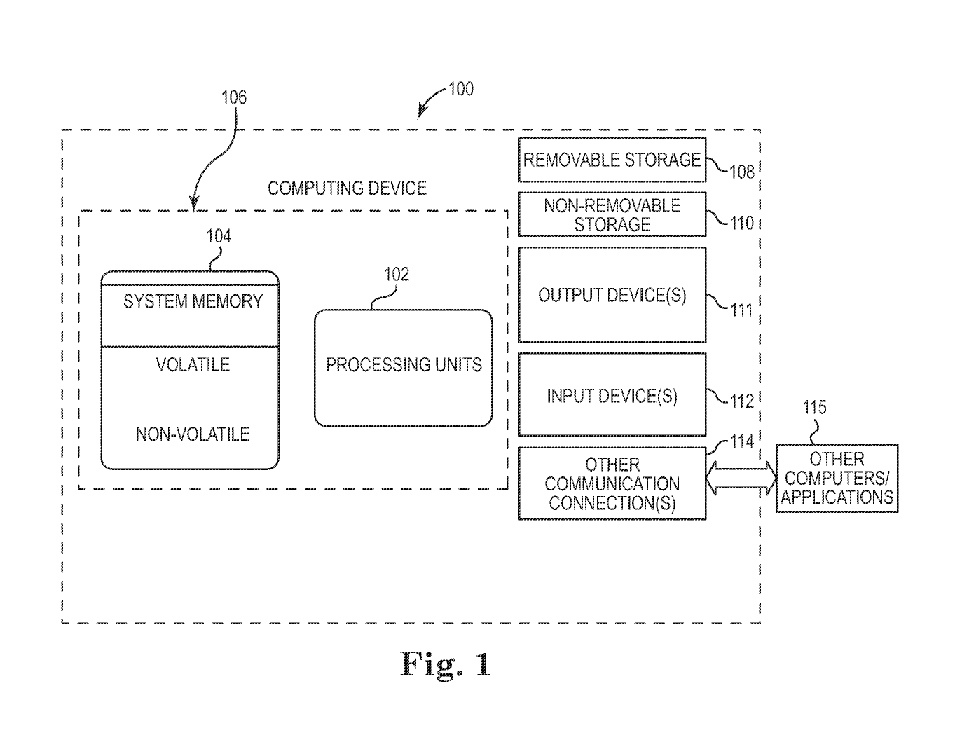

FIG. 1 illustrates an exemplary computer system that can be employed in an operating environment and used to host or run a computer application included on one or more computer readable storage mediums storing computer executable instructions for controlling the computer system, such as a computing device, to perform a process for propagating errors in floating point calculations using dataflow. The computer system can also be used to develop and/or run computer applications having processes for floating point error propagation.

The exemplary computer system includes a computing device, such as computing device 100. In a basic hardware configuration, computing device 100 typically includes a processor system having one or more processing units, i.e., processors 102, and memory 104. By way of example, the processing units may include, but are not limited to, two or more processing cores on a chip or two or more processor chips. In some examples, the computing device can also have one or more additional processing or specialized processors (not shown), such as a graphics processor for general-purpose computing on graphics processor units, to perform processing functions offloaded from processor 102. One particular processor is a Floating Point Unit (sometimes referred to as a math coprocessor) or FPU. In many example architectures, the FPU is integrated with processor 102. The FPU is designed to carry out operations on floating point numbers. Computer systems without hardware FPU can employ FPU emulators to assist with operations on floating point numbers. Memory 104 may be arranged in a hierarchy and may include one or more levels of cache. Depending on the configuration and type of computing device, memory 104 may be volatile (such as random access memory (RAM)), non-volatile (such as read only memory (ROM), flash memory, etc.), or some combination of the two. This basic configuration is illustrated in FIG. 1 by dashed line 106. Computing device 100 can take one or more of several forms. Such forms include a tablet, a personal computer, a workstation, a server, a handheld device, a consumer electronic device (such as a video game console), or other, and can be a stand-alone device or configured as part of a computer network, computer cluster, cloud services infrastructure, or other.

Computing device 100 can also have additional features or functionality. For example, computing device 100 may also include additional storage. Such storage may be removable and/or non-removable and can include, but is not limited to, magnetic or optical disks or solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse), pen, voice input device, touch input device, or other. Output devices 111 may include devices such as a display, speakers, printer, or the like.

Computing device 100 often includes one or more communication connections 114 that allow computing device 100 to communicate with other computers/applications 115. Example communication connections can include, but are not limited to, an Ethernet interface, a wireless interface, a bus interface, a storage area network interface, a proprietary interface. The communication connections can be used to couple computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the Internet, or other network.

Computing device 100 can be configured to run an operating system software program and one or more computer applications, which make up a system platform. A computer application configured to execute on computing device 100 includes at least one process (or task), which is an executing program. Each process provides the resources to execute the program. One or more threads run in the context of the process. A thread is the basic unit to which an operating system allocates time in processor 102. The thread is the entity within a process that can be scheduled for execution. Threads of a process can share its virtual address space and system resources. Each thread can include exception handlers, a scheduling priority, thread local storage, a thread identifier, and a thread context, or thread state, until the thread is scheduled. A thread context includes the thread's set of machine registers, the kernel stack, a thread environmental block, and a user stack in the address space of the process corresponding with the thread. Threads can communicate with each other during processing through techniques such as message passing.

An operation may execute in a thread separate from the main application thread. When an application calls methods to perform an operation, the application can continue executing on its thread while the method performs its task. Concurrent programming for shared-memory multiprocessors can include the ability for multiple threads to access the same data. The shared-memory model is the most commonly deployed method of multithread communication. Multiple threads execute on multiple processors, multiple processor cores, multiple logical nodes in a single processor core, and/or other classes of parallelism that are attached to a memory shared between the processors.

In one example, computing device 100 includes a software component referred to as a managed environment. The managed environment can be included as part of the operating system or can be included later as a software download. Typically, the managed environment includes pre-coded solutions to common programming problems to aid software developers to create applications, such as software programs, to run in the managed environment. Examples of managed environments can include an application framework or platform available under the trade designation .NET Framework from Microsoft Corporation of Redmond, Wash. U.S.A, and Java now from Oracle Corporation of Redwood City, Calif., U.S.A., as well as others and can include web application frameworks often designed to support the development of dynamic websites, web applications and web services.

An example of a managed environment is configured to accept programs written in a high-level compatible code of one or more programming languages to be used on different computer platforms without having to be rewritten for specific architectures. Typically, each program written in a compatible language will be compiled into a second platform-neutral language with corresponding language-specific compilers within a Common Language Infrastructure (CLI). In general, the second platform-neutral language is referred to as an intermediate language, or IL. The program in the second platform-neutral language is provided to a runtime compiler, such as one available under the trade designation Microsoft Common Language Runtime (CLR) from the in the .NET Framework platform, that compiles the program in the second platform-neutral language into a platform-specific machine-readable code that is executed on the current platform or computing device. As methods are called, the runtime arranges for them to be compiled to the machine code, in a process referred to as just-in-time compiling, and caches this machine code to be used the next time the method is called.

Native code is computer programming code that is compiled to run with a particular processor and its set of instructions. If the same program is run on a computer with a different processor, software can be provided so that the computer emulates the original processor. In this case, the original program runs in “emulation mode” on the new processor. Alternatively, the program can be rewritten and recompiled so that it runs on the new processor in native mode. A popular programming language used to deliberately choose native code over managed code is C++, which can be written to not run in the runtime, but instead runs natively on the machine. Native code through a native language compiler, such as C++ compiler, provides a relatively easy and well-defined way to read and modify floating point control and status registers.

Floating-point numbers are a preferable way to represent numbers in numerical operations because they can represent a wider range of numbers than integers and fixed-point numbers. Floating point refers to the radix point (e.g., decimal point in base ten or binary point in base two and in computing) that can be placed anywhere in the significant digits of a number. Varieties of floating point standards have been used, but the most commonly accepted standard for binary floating-point arithmetic is available from the Institute for Electrical and Electronics Engineers, or IEEE, as IEEE 754-2008 (approved in June 2008, which superseded IEEE 754-1985 of 1985), which includes provisions for exception handling. Other standards for floating point arithmetic are available, such as IEEE 854-1987 (standard for radix independent floating-point arithmetic). Still other standards are also available, such an “IBM standard” that can be used in mainframes manufactured and sold by IBM and a “Cray standard” that can be used with certain vector processor supercomputers such as those under the trade designation SV1.

Exceptions are run-time anomalies. Exceptions occur when a program executes abnormally because of conditions outside the program's control. IEEE 754-2008 specifies a special value called “Not-a-Number” (NaN) to be returned as the result of certain “invalid” operations, such as 0/0, ∞×0, or sqrt(−1) and others. For the purposes of this disclosure, the term NaN is used to mean the special value under the IEEE 754-2008 standard as well as similar special values used in other standards as well as any possible standard yet to be developed. In one example, there is a signaling NaN and a quiet, or silent, NaN. A signaling NaN applied in a floating-point arithmetic operation (including numerical comparisons) will cause an “invalid” exception. A quiet NaN or silent NaN applied in a floating-point arithmetic operation merely causes the result of operations involving the silent NaN to also be a NaN.

Invalid operations and other errors in floating point calculations are particularly vexing in parallel applications. Such errors in control flow programming can lead to unpredictable results that can be difficult to discover and address. Dataflow programming is better suited to discover and address these errors, but present dynamic error checking mechanisms are woefully burdensome. For example, the main path of a dataflow programming is typically configured to check for errors after each sub-computation, which typically involve conditional branching such as “If” statements. In one particular example, each sub-computation is checked to determine whether it yields a valid result, and the main path is resumed if the result of the sub-computation is valid. Error handling is invoked if the result of the sub-computation is invalid. Accordingly, costs are incurred on the main path with every sub-calculation regardless of whether an invalid result is generated, which can cause notable performance inefficiencies.

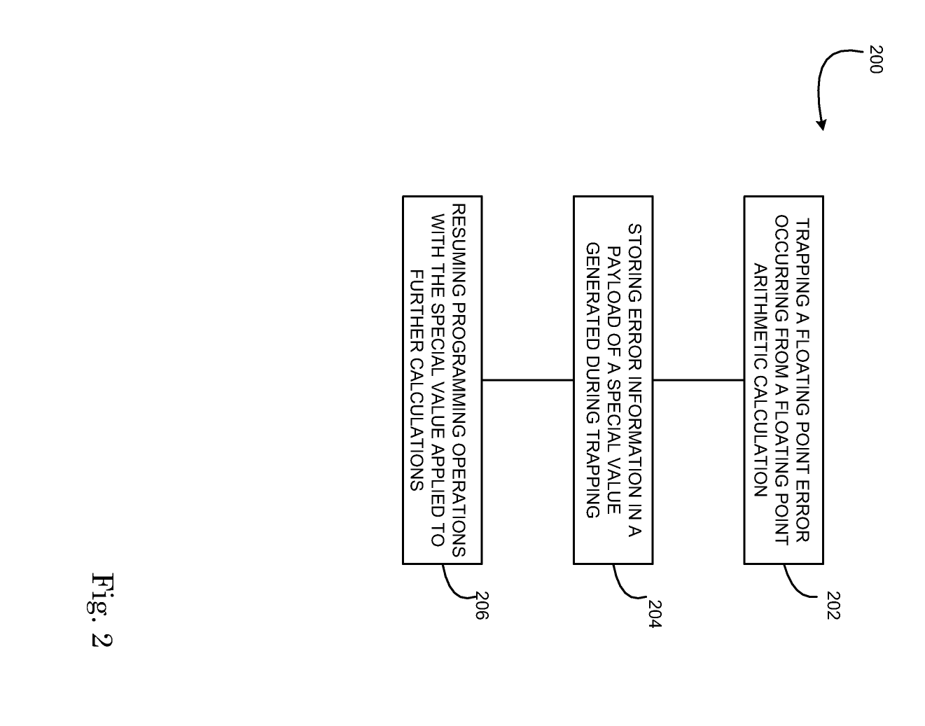

FIG. 2 illustrates a process 200 for lazily propagating floating point errors or invalid operations in sub-computations of parallelized applications that also preserves an illusion of sequential execution. In contrast to the previous floating point error detection mechanisms, process 200 generates a performance cost when an error is discovered rather than for each sub-computation on the main path can result in remarkably improved performance over previous error discovery methods in dataflow programming alone.

Process 200 includes trapping a floating-point error generated in a sub-computation at 202. Such an error will typically create a floating-point special value such as a NaN. Data regarding the error, or error information, is stored in the payload of the NaN at 204. Process 200 instructs the program to resume itself with the NaN applied to further computations, or sub-computations, along the main path at 206. Thus, the main path incurs a performance cost when process 200 is invoked to identify the special value resulting from an invalid operation, and subsequent errors resulting from that special value can be treated as silent errors until error values are generated, for example, at the end of the main path.

Many FPUs and FPU emulators include the facility to trap exceptional behavior when it occurs. In connection with process 200, the FPU or FPU emulator is configured to trap floating point errors at 202. In one example, the floating-point error is trapped with a vectored exception handler at a compiler, which typically occurs prior to other forms of exception handling.

Vectored exception handling is similar to structured exception handling but does include a few distinguishing features. For example, a vectored exception handler is not associated with a specific function or with a stack frame. Additionally, the runtime compiler can avoid keywords such as “try” or “catch” to add a new handler to a list of handlers. Still further, a vectored exception handler can be coded into a program rather than exist as a byproduct of try/catch statements. In the .NET Framework platform, an AddVectoredExceptionHandler application programming interface (API) takes a function pointer parameter and adds the address of the function to a linked list of registered handlers. Because the system uses a linked list to store the vectored exception handlers, a program can install as many vectored handlers as desired. When an exception occurs, the vectored exception handler list is processed before a structured exception handler list. This works out well for compatibility with existing code.

A NaN is automatically generated with the floating-point error. The generated NaN, however, does not include a payload. Process 200 generates error information and stores the error information, or packs the error information, as a NaN payload at 204, when the error is trapped. Examples of a payload can include information to identify the error as well as the location where the error occurred. In one example, the payload can include a key to a map location elsewhere that can include such items as line number, cause of error, stack information, and other relevant information. When an error is trapped in this example, error information is stored in memory 104, and the payload provides a key to the location in memory 104. In this example, the amount of error information can exceed the size limits of the payload. In one example, the error information can be stored in the memory even after the program has resumed at 206.

After the main path is instructed to resume at 206, a cost of one trap per error propagated has incurred. Resulting errors will occur silently and with little or no adverse to performance of the remaining main path. The trapped error can be detected in the final result of the computation, which is also an error.

The process 200 can also be configured to trap other floating point conditions, and record them for future use. For example, the process can be configured to trap exceptional behaviors such as when an exponent is too large or too small to be included in the exponent field, such as overflow and underflow, respectively, as well as others. While these exceptional behaviors are not “errors” in the strictest sense, errors for the purposes of this disclosure in process 200 can include errors in the strictest sense as well as exceptional behaviors.

A simplified example is illustrated using A=+Infinity; B=0; C=−Infinity; D=A*B; E=A+C; and F=D+E. The sub-computation D=A*B, or (+Infinity)*0, results in an invalid operation under the IEEE 754-2008 standard, which is trapped and a first NaN is created with a payload including the error information. The sub-computation E+A+C, or (+Infinity)+(−Infinity), also result in an invalid operation under the IEEE 754-2008 standard, which is also trapped and a second NaN is created with a payload including that error information. A sub-calculation such as F=D+E will silently propagate the first and second NaN as if no error has occurred.

It is contemplated that process 200 can be selectively applied to parallelized calculations. For example, if a calculation is expected to create an extremely large number of errors, dynamic checks may be more efficient than process 200. In such circumstances, for example, a library can temporarily disable the automatic handling of process 200 in favor of dynamic error checking.

In circumstance where control-flow decision is based on an invalid operation, the possibility exists for making an incorrect decision and subsuming the error. In such cases, process 200 can be configured to also trap this condition and create another special error value to be reconciled with the final return value of the computations. If the final value is computed based on the flawed control-flow decision, it is marked as an error and then propagated.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A process, comprising:
trapping a floating point error occurring from a floating point arithmetic calculation;
storing information regarding the error as a payload of a special value generated during the trapping; and
resuming program operations with the special value applied to further calculations dependent on the floating point arithmetic calculation.

2. The process of claim 1 wherein the floating point error occurs as a result of an invalid operation.

3. The process of claim 1 wherein the trapping is performed with a vectored exception handler.

4. The process of claim 3 wherein the vectored exception handler is processed prior to any additional exception handlers.

5. The process of claim 1 wherein the special value is a not-a-number as defined in IEEE 754-2008 standard.

6. The process of claim 5 wherein the not-a-number is a silent not-a-number.

7. The process of claim 1 wherein the special value causes the further calculations to result in the special value.

8. The process of claim 1 wherein the payload is a key to a map location.

9. The process of claim 1 wherein data at the map location includes a line number of the error, a cause of error, and stack information at a time of the error.

10. The process of claim 1 wherein the computation is a sub-computation.

11. A process of propagating a floating point error in dataflow, comprising:
trapping a floating point error occurring from an invalid operation of a floating point arithmetic calculation in a plurality of parallelized floating point arithmetic calculations in dataflow;
storing information regarding the error as a payload of a special value generated during the trapping; and
resuming dataflow with the special value applied to further calculations dependent on the floating point arithmetic calculation.

12. The process of claim 11 wherein the trapping occurs prior to other exception handling.

13. The process of claim 11 wherein the invalid operation includes 0/0, ∞×0, +∞+−∞, or sqrt(−1).

14. The process of claim 11 wherein the special value is generated without a payload.

15. The process of claim 11 wherein the special value is silent not-a-number according IEEE 754-2008 standard.

16. The process of claim 11 and further comprising performing a control-flow decision dependent on the invalid operation, and trapping the control flow decision.

17. The process of claim 11 and further comprising temporarily suspending trapping in deference to dynamic error checking in dataflow.

18. A process for propagating floating point errors, comprising:
performing a plurality of parallelized floating point arithmetic calculations in a dataflow;
trapping an error, during exception handling, from an invalid operation during a floating point arithmetic calculation of the plurality of parallelized floating point arithmetic calculations;
generating a special value as a result of the invalid operation;
storing information regarding the error into a payload of the special value;
resuming the plurality of parallelized floating point arithmetic calculation; and
applying the special value in calculations dependent on the floating point arithmetic calculation.

19. The process of claim 18 and further comprising returning a final result of the plurality of parallelized floating point arithmetic calculations including the trapped error.

20. The process of claim 19 wherein the program includes a spreadsheet.
